(19) United States
(12) Patent Application Publication
(10) Pub. No.: US 2002/0123418 A1
(43) Pub. Date: Sep. 5, 2002

(54) Laser system for making creases in cardboard

(76) Inventors: Michael R. Davison, (US); Jules P. Faskas, (US)

Correspondence Address: W. Edward Johansen, 11661 San Vicente Boulevard, Los Angeles, CA, 90049, US

(21) Appl. No.: 09/735,817

(22) Filed: Dec. 12, 2000

(51) Int. Cl. B31F 7/00

(52) U.S. Cl. 493/340

(57) ABSTRACT

The present invention is a method of folding a cardboard along a fold-line. The cardboard consists of an outside layer, a middle layer and an inside layer. The method includes the step of using a laser system to cut a first slot and a second slot in the inside layer. The first and second slots are disposed parallel to the fold-line which is disposed between the first and second slots. The method also includes the step of folding the cardboard along the fold-line. When the outside layer is pulled tight the inside layer and the middle layer are pushed inward. The first and second slots must be wide enough to allow the inside layer to easily deform when the cardboard is folded.

### BACKGROUND OF THE INVENTION

The invention relates to a laser system for making creases in cardboard which is used for forming folding cartons.

Folding cartons are currently used in all types of products ranging from packages and boxes to folders and greeting cards.

Folding cartons are widely manufactured on printing presses and converting machines. Tooling for this process is expensive and time-consuming to align each time a different folding carton is made. Techniques have been devised to digitally cut out the carton pattern but until now, no effective means has been found to eliminate the tooling to create the crease.

U. S. Pat. No. 4,742,206 teaches a cutter which includes a laser. The cutter produces slots of computer-controlled size and pattern in work-pieces of cylindrical-shell configuration. The work-pieces is mounted for incrementally controlled rotation about the axis of each work-piece, in coordination with incrementally controlled longitudinally guided displacement of the laser along a path parallel to the work-piece rotation axis. The slotted work-pieces become locators for knife elements and indentation-tool elements, so that when secured to the cylindrical body of a cutting roll, the resulting tool will find use in a rotary printing process for continuously printing, cutting and creasing cardboard or other box material. The computer-control of slot pattern enables a user shop to quickly adapt its cutting and creasing operation to the custom size and configuration requirements of different customers.

U. S. Pat. No. 3,909,582 teaches a method which forms a line of weakness in at least one but not all layers of a multi-layer laminate. The method includes the steps of effecting relative movement between a laser beam.

U. S. Pat. No. 3,937,109 teaches a cutting and/or creasing die includes a sheet. The sheet is to be bent around and attached to a roller of a rotary machine for producing blanks from a strip of material, particularly for producing creased blanks for boxes from cardboard or similar material.

U. S. Pat. No. 4,050,362 teaches an apparatus which cuts, creases and/or embosses sheets of cardboard, paper of similar material. The apparatus includes a tool plate or die having steps therein in the form of parting steps and ribs and/or grooves to form creases. A resilient elastic member is employed to press the cardboard web down against the various steps in the tool plate. The size and configuration of the steps and the tool plate causes severing or cutting of the cardboard or creasing or embossing. The apparatus is for use with rotational as well as planar or reciprocating blanking machines and a variety of different tool plate constructions. The process includes resilient urging of the sheet against the die piece with the elastic member causing deformation of the sheet to conform to the tool plate.

U. S. Pat. No. 3,648,573 teaches an apparatus which forms cartons. The apparatus includes a feeder having a pivoted suction cup and a cooperating vacuum belt conveyor which individually feeds carton blanks to a former. The former includes a rotary table which has a plurality of female forming dies radially positioned thereon. A ram-type male die is reciprocally mounted above the table to cooperate with each forming die to form the carton blank into tray form.

U. S. Pat. No.3,744,384 teaches a roller which cuts, creases, perforates or embosses sheet materials, such as paper, cardboard or thin plastic.

U. S. Pat. No. 3,965,327 teaches an apparatus which cuts a predetermined pattern in a moving web of material, such as paper, cardboard or the like. A laser beam is deflected by a series of pivotable mirrors. The pivoting of the mirrors is controlled so as to cause the laser beam to trace and cut the predetermined pattern. The laser beam moves only in rectilinear motion, as does the web of material to be cut.

U. S. Pat. No. 5,321,227 teaches an apparatus which deeply cuts a material which covers a substrate. The material absorbs laser radiation and enables the transforming of a beam from a laser source into a thin pencil of rays to create a focus sing field having a thin blade shape including a large focussing depth spanning several millimeters and having variations in energy density of laser radiation less than a predetermined value so that the laser radiation is sufficient to remove an entire thickness of the material, by fusion or ablation, within the focussing field.

U. S. Pat. No. 5,138,923 teaches a rotatable cylinder to which is secured a unitary sleeve having cutting lands for cutting and creasing sheet of cardboard. The sleeve is secured to the cylinder to prevent relative movement during the cutting process.

U. S. Pat. No. 6,071,225 teaches a resilient scoring rule for a rotary cutting die which produces a creased or indented line in cardboard or paperboard along which line the cardboard is subsequently folded when formed into a final product, such as a container. The scoring rule has a longitudinally extending, centrally disposed projecting web and opposed, cantilevered, symmetrical inwardly directed left and right ears having ends generally adjacent the central web.

U. S. Pat. No. 3,981,213 teaches a rotary apparatus which cuts and creases sheet of cardboard to form a folding carton. The sheet material is fed through a printing press in a conventional manner from a roll and then through the rotary apparatus to cut out and crease the folds of the carton blank.

U. S. Pat. No. 4,184,770 teaches a monitor which detects the presence of folds or creases in the surface of a moving web of material such as paper. The monitor utilizes a laser light beam arranged parallel to the surface of the web and transversely to the direction of movement thereof. A light detector such as a differential photoelectric detector senses changes in the light beam caused by impingement on a fold or crease.

U. S. Pat. No. 5,444,210 teaches an apparatus which provides flying-shear cutting of thin-layer material, reeled off from a coil, by laser radiation, especially metal strips, fabrics, synthetic resins, paper, cardboard and composite materials.

U. S. Pat. No. 5,611,949 teaches a laser cutter includes a controller, a laser apparatus, a conveyor belt system, a position encoder, an optical control system and a registration sensor. The relationship of travel on the conveyor belt system and the cutting plane of the laser apparatus.

U. S. Pat. No. 5,421,933 teaches a labeler which includes a controller, a web dispenser, a laser and a label application assembly. The web dispenser dispenses a web of label material which has a coating of a non-tacky adhesive. The labeler subsequently activates the non-tacky adhesive and cuts the web using beams of light energy from the laser to produce labels therefrom. The labeler then applies the labels to respective packages. The laser includes two lasers and mirrors. Each laser produces upper and lower, continuous, narrow laser beams of light energy and produces a pulsed, broad beam of light energy which is routed by the mirrors to impinge upon the rear face of the web in order to activate the adhesive coating. The laser includes two, 80 watt, carbon dioxide lasers. The lasers produce respective beams of light energy and are available from Laser Machining, Inc. Upper and lower laser beams of light energy are shiftable in both the x-axis and the y-axis in the orientation in order to cut through the web as it moves past the laser. These movements are controlled by a beam positioner which the controller operates. The beam positioner and the controller are both available from General Scanning, Inc. The controller is programmed to control the movements of beams of light energy in coordination with the movement of the web and the operation of the application assembly.

U. S. Pat. No. 5,624,520 teaches a labeler which dispenses a web of label material having a coating of non-tacky adhesive, subsequently activates the adhesive, cuts the web using a pair of laser beams to produce labels therefrom, and then applies the labels to respective packages. A carrier sheet is separated from an adhered web whereupon the web is then cut using a laser beam to form labels and a waste matrix

U. S. Pat. No. 5,614,115 teaches a laser-cutter which cuts textile or leather clothing material adhered on a stiff tacky backing sheet. The laser cutter includes a laser which produces a laser beam, a guide head for reflecting and focusing the laser beam onto the sheet-backed clothing material and an optical sensor mounted on the guide head for recognizing the shape or a pattern marked on the material.

U. S. Pat. No. 4,680,442 teaches a laser cutter which uses a beam of light energy to cut multiple sheets of fabric and then removes the smoke and debris from the fabric.

U. S. Pat. No. 5,556,826 teaches laser perforation of all types of paper. The paper has sufficient strength characteristics to survive stresses imposed during handling such as experienced in sheet feed processes. The paper so perforated is readily separable along the perforation line when separation is desired.

U. S. Pat. No. 6,136,130 teaches a high strength, flexible, foldable and printable sheet, such as a label sheet or cardstock. The sheet is provided with a line of weakness.

U. S. Pat. No. 6,130,402 teaches a system which marks or perforates by a laser. The system includes a laser, a supply unit, a controller and a deflector which produces different beam deflection angles.

U. S. Pat. No. 6,103,989 teaches a system which forms discrete etched adhesive labels from continuous label stock. The system includes a de-laminator, a laser etching module, a re-laminator and a cutting module. The de-laminator separates and displaces the release liner from the face stock. The laser etching module scans a high power density laser beam over the separated face stock to produce a predetermined pattern of etched regions. The etched face stock is then reattached to the functionally intact release liner by the re-laminator. Finally, the cutting module cuts through the face stock at regular intervals to form discrete adhesive labels.

U. S. Pat. No. 6,024,830 teaches a label-forming and applying apparatus which dispenses a web of label material presenting individual labels with respective boundaries, and individually cuts such labels using one or more laser beams. The laser unit is equipped with a controller having an electronic memory which stores information about the label boundaries, so that the laser unit can be precisely controlled in order to successively cut labels from the web.

An applicator assembly is also provided which picks up the cut labels and transfers the labels to an application station where they are applied to respective articles.

The inventor incorporates the teachings of the above-cited patents into this specification.

### SUMMARY OF THE INVENTION

The present invention is generally directed to a method of folding cardboard along a fold-line. The cardboard consists of an outside layer, a middle layer and an inside layer.

In a first separate aspect of the present invention, the method includes the step of using a laser system to cut a first slot and a second slot in the inside layer. The first and second slots are disposed parallel to the fold-line which is disposed between the first and second slots.

In a second separate aspect of the present invention, the method also includes the step of folding the cardboard along the fold-line. When the outside layer is pulled tight the inside layer and the middle layer are pushed inward. The first and second slots must be wide enough to allow the inside layer to easily deform when the cardboard is folded.

Other aspects and many of the attendant advantages will be more readily appreciated as the same becomes better understood by reference to the drawing and the following detailed description.

The features of the present invention which are believed to be novel are set forth with particularity in the appended claims.

### DESCRIPTION OF THE DRAWINGS

FIG. 1 is a schematic drawing of cardboard consisting of an outside layer, a middle layer and an inside layer.

FIG. 2 is a schematic drawing of a die set which includes a male die and a female die and which is used to create a crease in the cardboard of FIG. 1.

FIG. 3 is a schematic drawing of the creased cardboard of FIG. 2 after it has been folded.

FIG. 4 is a schematic drawing of the cardboard of FIG. 1 after a laser system has machined a first slot and a second slot in the inside layer in the cardboard with the first and second slots being disposed parallel to a fold-line to digitally create a crease in accordance with the present invention.

FIG. 5 is a schematic drawing of the creased cardboard of FIG. 4 after it has been folded.

### DESCRIPTION OF THE PREFERRED EMBODIMENT

Referring to FIG. 1 cardboard 10 is used for forming a folding carton. The cardboard is creased and folded into its intended use. The cardboard 10 is usually paper stock and consists of an outside layer 11, a middle layer 12 and an inside layer 13. The outside layer 11 is normally strong paper and is appropriate for decorating. The middle layer 12 is soft. The inside layer 13 is thinner and is combined with the middle layer 12 to provide stiffness.

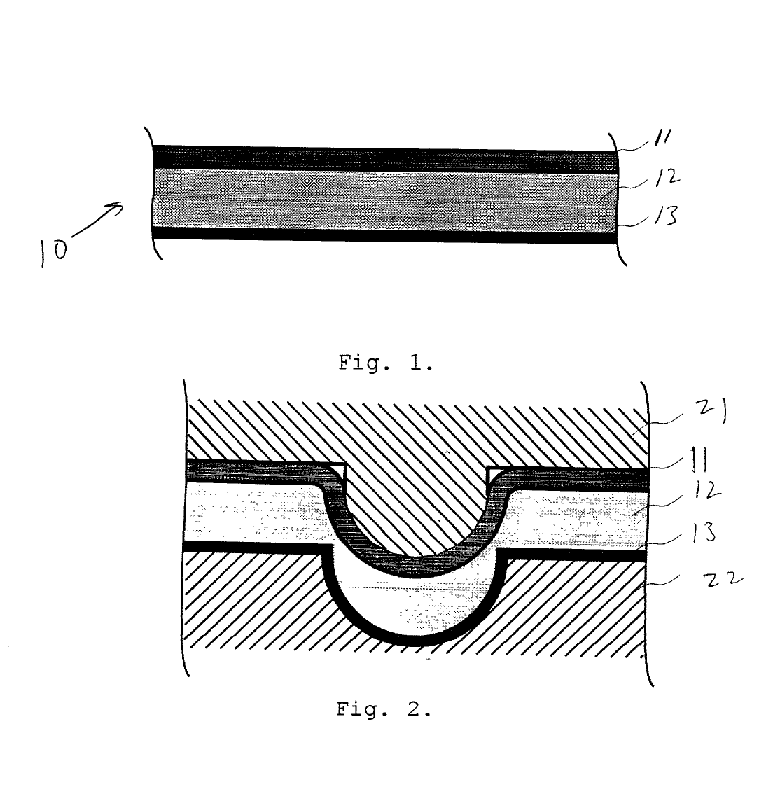

Referring to FIG. 1 in conjunction with FIG. 2 a die set 20 includes a male die 21 and a female die 22. The die set 20 is used to crease the cardboard 10 inward.

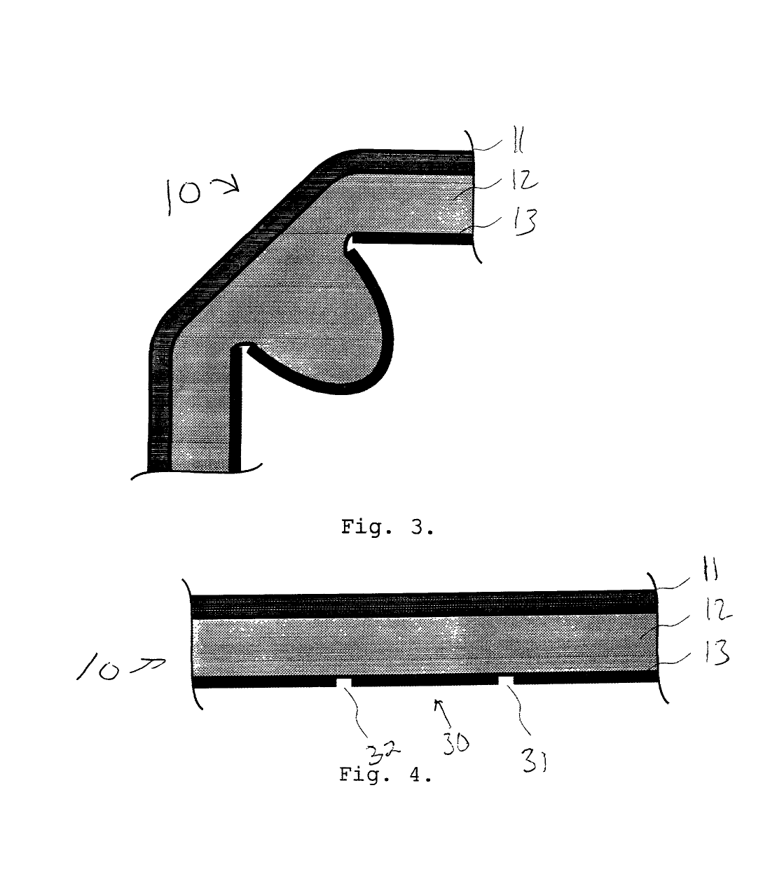

Referring to FIG. 3 a folding apparatus folds the cardboard 10 inward so that the outside layer 11 is exposed and the inside layer 13 is mostly hidden from view. As the cardboard 10 is folded the outside layer 11 is pulled tight while the inside layer 13 and the middle layer 12 are pushed inward. All of the strength in the corner is from the outside layer 11.

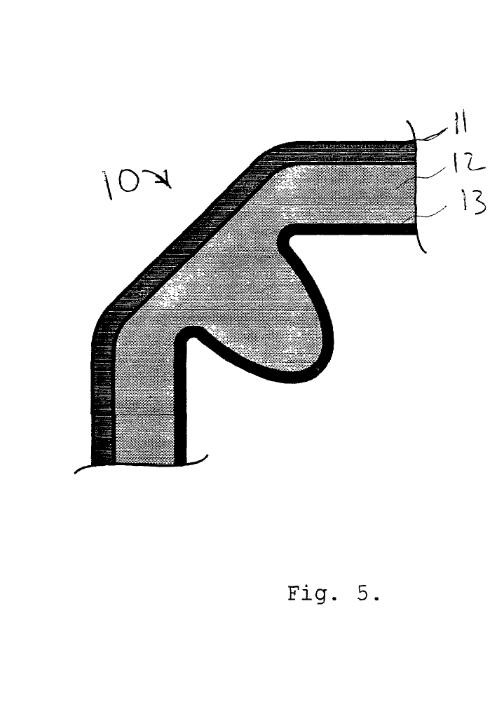

Referring to FIG. 4 in conjunction with FIG. 1 a laser system machines a first slot 31 and second slot 32 through the inside layer 13 on both sides of an intended fold-line 30 to digitally create a crease. The first and second slots 31 and 32 are disposed parallel to the fold-line 30. The spacing between the first and second slots 31 and 32 determines the effective bend radius. The cardboard 10 is the same as before but instead of the crease being made with the die set 20 the laser digitally creates the crease.

Referring to FIG. 5 when the cardboard 10 is folded by standing folding mechanism the outside layer 11 is pulled tight while the inside layer 13 and the middle layer 12 are pushed inward. All of the strength in the corner is from the outside layer 11. The first and second slots 31 and 32 must be wide enough to allow the inside layer 13 in order to easily deform when the cardboard 10 is folded. Usually, just enough material will be removed to create the proper fold thus minimizing the cost of the fold, but as much of the inside layer 13 between the cuts can be removed if desired. The first and second slots 31 and 32 may be enlarged so that they become joined to form one slot.

The laser cutting system may include a controller, a laser apparatus, a beam steering and focus apparatus, a conveyor belt system and a position encoder. The controller may also include a computer. The computer has a CPU, a ROM and a RAM. The laser apparatus includes a laser tube and a power supply. The beam steering and focus apparatus 113 includes an X-galvanometer, an X-mirror driver, a Y-galvanometer, a Y-mirror driver, a Z-galvanometer and a Z-lens driver. The laser apparatus is optically coupled to the beam steering and focus apparatus. The laser cutting system also includes a registration sensor. The registration sensor is optically coupled to the conveyor belt system. The position encoder is mechanically coupled to the conveyor belt system. The controller is electrically coupled to the position encoder. The controller is also electrically coupled to the power supply of the laser apparatus 112 and the X-mirror driver, the Y-mirror driver and the Z-lens driver of the beam steering and focus apparatus. The controller also includes a tracking module. The tracking module has a pre-scaler, a counter, a sync buffer, a dual port RAM buffer and a decoder. The pre-scaler is electrically coupled to the position encoder. The position encoder generates a first input signal and sends the first input signal to the pre-scaler. The counter is electrically coupled to the pre-scaler. In response to the first input signal from the position encoder the pre-scaler generates a pulse signal and sends the pulse signal to the counter. The sync buffer is electrically coupled to the registration sensor. In response to optical detection of a leading edge of a substrate on the conveyor belt system the registration sensor generates a second input signal and sends the second input signal to the sync buffer. The counter is also electrically coupled to the sync buffer. In response to the second input signal from the registration sensor the sync buffer generates a reset pulse signal and sends the reset pulse signal to the counter. The dual port RAM buffer is electrically coupled to the counter. In response to the pulse signal and the reset pulse signal from the prescaler and the sync buffer, respectively, the counter generates an address signal and sends the address signal to the dual port RAM buffer. The dual port RAM buffer is also electrically coupled to the computer. The computer generates a computer output signal and when the dual port RAM buffer is empty the computer sends the computer output signal to the dual port RAM buffer. The decoder is electrically coupled to the dual port RAM buffer. In response to the address signal and the computer output signal from the counter and the computer, respectively, the dual port RAM buffer generates a data output signal and sends the data output signal to the decoder. The decoder is electrically coupled to the power supply of the laser apparatus, the X-mirror driver, the Y-mirror driver and the Z-lens driver of the beam steering and focus apparatus. In response to the data output signal from the dual port RAM buffer the decoder generates four output signals. Each output signal from the decoder controls one of the power supply of the laser apparatus, the X-mirror driver, the Y-mirror driver and the Z-lens driver of the beam steering and focus apparatus, respectively.

The laser system can also be used to cut out the carton thereby creating a complete digital solution to carton finishing on a printing press. Using the laser system eliminates hard tooling and the problems associated with the conventional techniques. Any tooling changes may be entirely done in software.

From the foregoing it can be seen that use of a laser system to digitally create a crease in a cardboard along a fold-line has been described.

Accordingly it is intended that the foregoing disclosure and drawings shall be considered only as an illustration of the principle of the present invention.

What is claimed is:

1. A method of folding a cardboard along a fold-line, the cardboard consisting of an outside layer, a middle layer and an inside layer, said method comprising the steps of:
a. using a laser system to cut a first slot and a second slot in the inside layer wherein said first and second slots are disposed parallel to the fold-line which is disposed between said first and second slots whereby the cardboard is weakened adjacent to the fold-line; and
b. folding the cardboard so that when the outside layer is pulled tight the inside layer and the middle layer are pushed inward whereby each of said first and second slots must be wide enough to allow the inside layer to easily deform when the cardboard is folded.
